(19) United States
(12) Patent Application Publication
(10) Pub. No.: US 2007/0239696 A1
(43) Pub. Date: Oct. 11, 2007

(54) Interactive relational graphic solutions

(75) Inventors: Bin Xu, Beijing-Mill (CN); Yong-Gang-Steele Mao, Beijing-Sigma (CN)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/392,190

(22) Filed: Mar. 28, 2006

(51) Int. Cl. G06F 17/30

(52) U.S. Cl. 707/4

(57) ABSTRACT

Interactive relational graphic solutions facilitate an economical teaching tool to explain a plethora of educational topics. The solutions are associated with a graphics capable application of a computing device. The solutions facilitate user interaction by graphically correlating functions through a series of interactive control points. The correlation may include a moveable control point and lead lines to indicate associated coordinates as the user moves the control point of the solution. Such a solution reduces the time required to explain an educational topic and helps facilitate the educational process.

### BACKGROUND

In a typical teaching environment, a teacher may explain concepts associated with mathematics, physics, chemistry and/or other educational topics. In explaining such concepts, a teacher may draft figures on a blackboard or generate a graphic on a computing device to explain the concept. When a process is dynamic and/or relative, the teacher may be required to draft several versions of figures on the blackboard or computing device to convey the concept. Such versioning is time consuming and a hindrance in an educational environment.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter.

Interactive relational graphic solutions facilitate an economical teaching tool to explain a plethora of relative and dynamic educational topics. The solutions are associated with a graphics capable application of a computing device. The solutions facilitate user interaction by graphically correlating functions through a series of interactive control points. The correlation may include a moveable control point and lead lines to indicate associated coordinates as the user moves the control point of the solution. Such a solution reduces the time required to explain an educational topic and helps facilitate the educational process.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates an exemplary computing device;

FIG. 2 represents one exemplary system overview for facilitating interactive relational graphic solutions;

FIG. 3 represents one exemplary interactive relational graphic solution; and

FIG. 4 represents an operational flow diagram for implementing an interactive relational graphic solution.

### DETAILED DESCRIPTION

Embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope. Embodiments may be practiced as methods, systems or devices. Accordingly, embodiments may take the form of an entirely hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the invention. Accordingly, the logical operations making up the embodiments described herein are referred to alternatively as operations, steps or modules.

In many teaching environments, a teacher may explain concepts associated with mathematics, physics, chemistry and/or other educational topics. Interactive relational graphic solutions are implemented to facilitate an economical teaching tool to explain a plethora of educational topics. The solutions are associated with a graphics capable application of a computing device. The solutions facilitate user interaction by graphically correlating functions through a series of interactive control points. For example, a solution may include graphically correlating coordinates of a circle with coordinates of a sine graph in order to demonstrate the association between circular trigonometric functions and triangular trigonometric functions. The correlation may include a moveable control point and lead lines to indicate associated coordinates as the user moves a control point of the solution.

In this manner, a user may easily choose an interactive relational graphic solution to demonstrate. A user may interact with the solution to demonstrate a correlation between functions in a real time manner. Such a demonstration reduces the time required to explain an educational concept and helps facilitate the educational process.

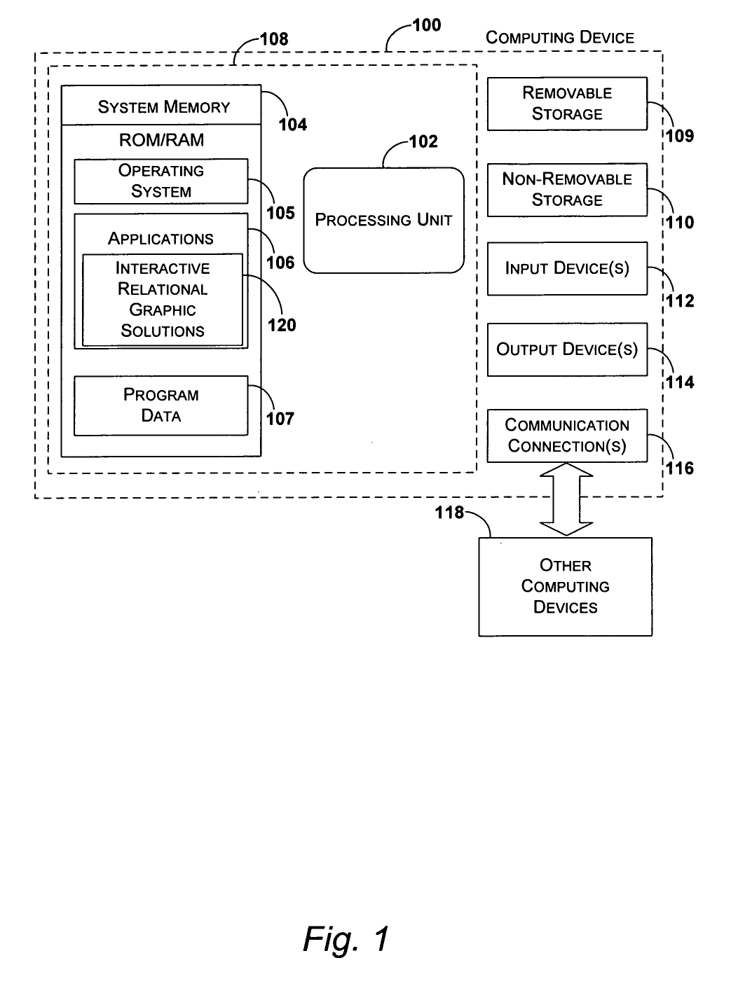

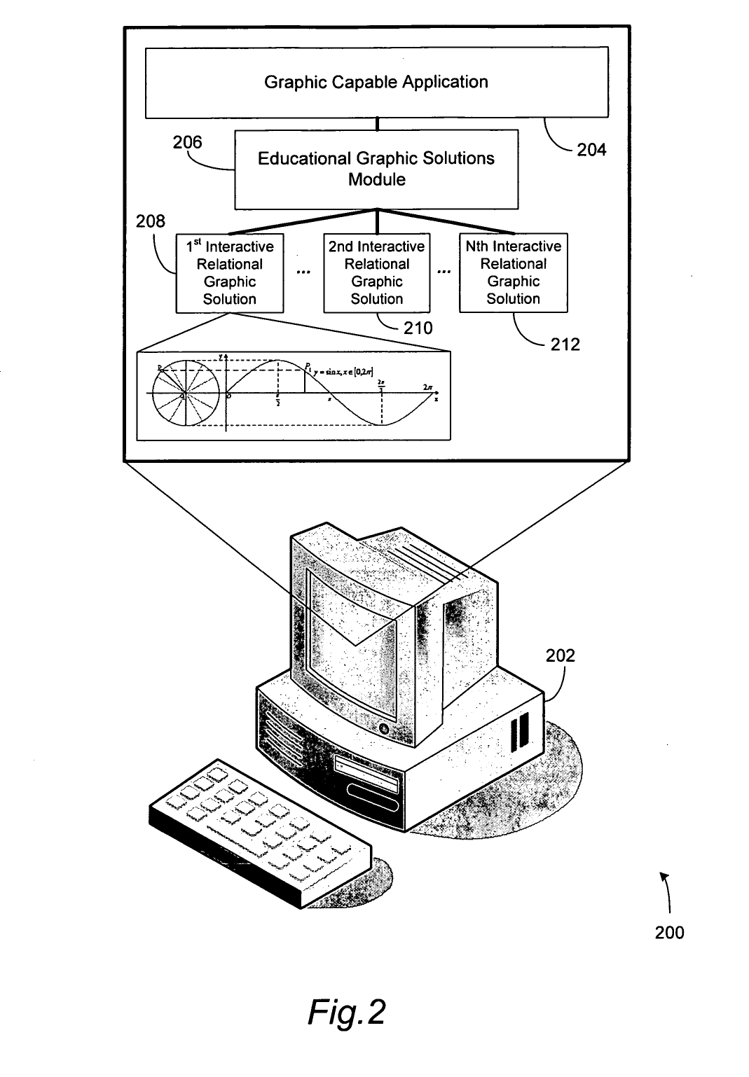

FIG. 2 represents one exemplary system overview for facilitating interactive relational graphic solutions. System 200 represents a modular overview of a few aspects of computing device 202. In one aspect, computing device 202 may include computing device 100 represented in FIG. 1. System 200 represents a modular overview of computing device 202. System 200 may be integrated as a combination of software and hardware elements, an operating system or any combination thereof. Hardware, databases, software, applications, and/or programs referenced herein may be integrated as a single element or include various elements in communication with one another. Software and/or hardware elements are depicted herein for explanatory purposes only and not for limiting the configuration to multiple elements or a single element performing several functions unless specifically specified herein. For example, as depicted in FIG. 2, system 200 includes computing device 202 having graphic capable application 204, educational graphic solutions module 206, first interactive relational graphic solution 208, second interactive relational graphic solution 210, and Nth interactive relational graphic solution 212. Reference numbers 206-212 may include separate programs. Reference numbers 206-212 may also include a single program or any combination of single and multiple programs.

Computing device 202 may include graphics capable application 204. Graphics capable application 204 may include any application for, generating, maintaining, implementing and/or depicting a graphic. For example, graphics capable application 204 may include “MICROSOFT VISIO”, “MICROSOFT WORD”, “MICROSOFT EXCEL”, and/or “MICROSOFT POWERPOINT” of MICROSOFT CORPORATION located in Redmond, Wash.

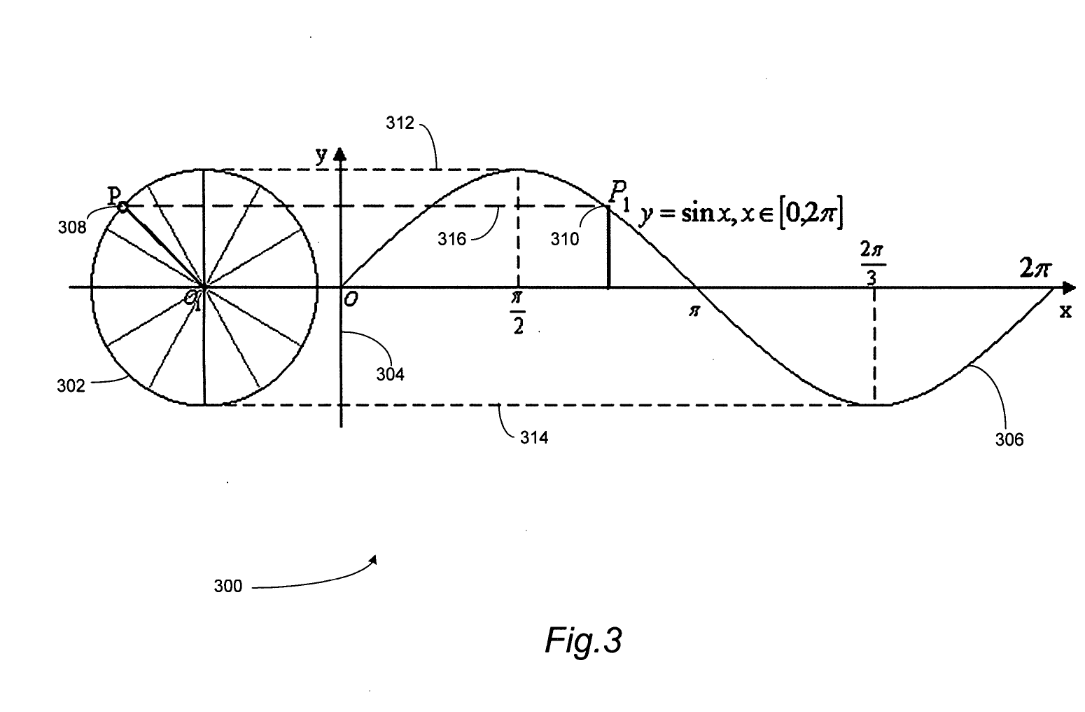

Educational graphic solutions module 206 may include several educational tools for graphic capable application 204. Educational graphic solutions module 206 may be initially associated with graphic capable application 204 and/or educational graphic solutions module 206 may be an add-on program. In one aspect, educational graphic solutions module 206 includes one or more interactive relational graphic solutions. Interactive relational graphic solutions may include any solution for facilitating user interaction by graphically correlating functions through a series of interactive control points, as more fully set forth herein. First interactive relational graphic solution 208 is more fully described in association with FIG. 3.

FIG. 3 represents one exemplary interactive relational graphic solution. Interactive relational graphic solution 300 includes circle 302, coordinate system 304 and trigonometric function graphic 306. In one aspect, interactive relational graphic solution 300 is a graphic that relates two functions and provides interaction to dynamically depict the relationship. Circle 302 may be a unit circle or a circle having any size of radius. Coordinate system 304 may include a rectangular coordinate system, a polar coordinate system and/or any other type of coordinate system configured to graphically convey a relational concept. Trigonometric function graphic 306 includes a sine function. The sine function is mathematically correlated to circle 302. Even though the sine function is depicted in FIG. 3, circle 302 may be correlated to a cosine function and/or a tangent function in the same manner as set forth herein for the sine function. Moreover, interactive relational graphic solution 300 may include a three-dimensional interactive relational graphic solution. Although not depicted, such an embodiment includes a sphere, a three-dimensional coordinate system and three-dimensional trigonometric function object. Such an embodiment includes similar mathematical functions as described herein for the two dimensional embodiment.

Circle 302 includes circle control point 308. Circle control point 308 is an interactive control point. A user may select control point 308 and move control point 308 around circle 302. Similarly, trigonometric function graph 306 includes trigonometric control point 310. Control point 310 is an interactive control point. A user may select control point 310 and navigate control point 310 on trigonometric function graph 306. Circle control point 308 and trigonometric control point 310 are associated with one another. For example, a user may move circle control point 308 and trigonometric control point 310 moves to a corresponding point on trigonometric function graph 306. Similarly, a user may move trigonometric control point 310 and circle control point 308 moves to a corresponding point on circle 302. Even though FIG. 3 depicts a sine function, the association of circle control point 308 and trigonometric control point 310 may also be facilitated in association with a cosine function or a tangent function.

Interactive relational graphic solution 300 may also include one or more lead lines. Circle 302 may include positive lead line 312 and negative lead line 314. Positive lead line 312 extends from a ninety-degree point of circle 302 to the positive amplitude point of trigonometric function graph 306. Negative lead line 314 extends from a two hundred seventy-degree point of circle 302 to the negative amplitude point of trigonometric function graph 306. In one aspect, a user determines the radius of circle 302. In such a situation, the amplitude of trigonometric function graph 306 changes. In accordance, positive lead line 312 and negative lead line 314 are spaced closer or further apart depending on the determined radius of the circle.

Control point lead line 316 connects circle control point 308 and trigonometric control point 310. In one aspect, control point lead line 316 remains horizontal and moves vertically as a user navigates a control point associated with interactive relational graphic solution 300. In the situation where the trigonometric function graph 306 includes a tangent graph, positive lead line 312 and negative lead line 314 may be omitted.

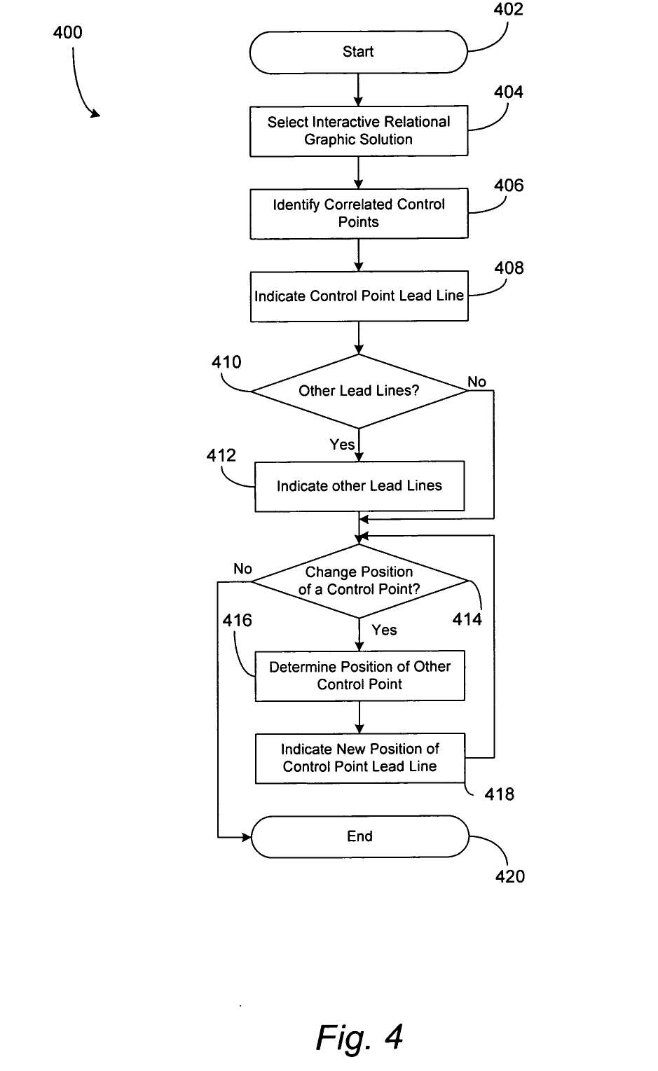

FIG. 4 represents an operational flow diagram for implementing an interactive relational graphic solution. Operational flow 400 begins at start operation 402 and continues to operation 404. At operation 404, an interactive relational graphic solution is selected. The selection may include a user selecting an interactive relational graphic solution from a database of solutions. The database of solutions may be associated with a graphics capable application. In another aspect, the database of solutions may include an add-on module to an existing program.

Correlated control points are identified at operation 406. For example, a control point may be identified on a circle and an associated control point may be identified on a sine function graph. At operation 408, a control point lead line is indicated between the correlated control points.

Operational flow 400 continues to decision operation 410 where it is determined whether to indicate other lead lines. When it is determined not to indicate other lead lines, operational flow 400 continues to decision operation 414. When it is determined to indicate other lead lines, operational flow 400 continues to operation 412. At operation 412, other lead lines are indicated. For example, other lead lines may include a positive lead line that indicates a positive amplitude of a trigonometric function. Other lead lines may also include a negative lead line that indicates a negative amplitude of a trigonometric function. As still another example, other lead lines may be indicated when associated with a sine and/or cosine function and not indicated in association with a tangent function. Other lead lines may be indicated in any manner to help identify associated entities of an interactive relational graphic solution.

Operational flow 400 continues to decision operation 414 where it is determined whether a control point has changed position. The change of position may be associated with a circle control point or a trigonometric control point. In one aspect, a user may select a control point with a mouse, keyboard, joystick or the like. The user may then navigate the selected control point in association with the interactive relational graphic solution. Operational flow 400 continues to operation 416 where the position of the other control point is determined. In one aspect, as the control point is moved, the other control point is moved simultaneously to correspond in real time. For example, a circle control point may begin at zero degrees and be moved to ninety degrees. The sine of 0 degrees is 0 and the sine of 90 degrees is 1. Thus, the trigonometric control point moves on the trigonometric function graph from y=0, x=0 to y=1, x=90 degrees. As another example, a trigonometric control point may begin at y=0 and x=90 degrees and be moved to y=0 and x=0 degrees. The circle control point, thus, moves from a 180 degree point to the 0 degree point on the circle.

Operational flow 400 continues to operation 418 where a new position of the control point lead line is indicated. Operational flow 400 loops back to decision operation 414. Where the position of the control point is changed, operational flow 400 continues as stated above. Where the position of the control point is not changed, operational flow 400 continues to end operation 420.

In the manner set forth herein, a user may easily choose an interactive relational graphic solution to demonstrate. A user may interact with the solution to demonstrate a correlation between functions in a real time manner. Such a demonstration reduces the time required to explain an educational concept and helps facilitate the educational process.

Referring to FIG. 1, an exemplary system for implementing the invention includes a computing device, such as computing device 100. In a basic configuration, computing device 100 may include any type of stationary computing device or a mobile computing device. Computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes operating system 105, one or more applications 106, and may include program data 107. In one embodiment, applications 106 further include application 120 for interactive relational graphic solutions. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as a keyboard, mouse, pen, voice input device, touch input device, etc. Output device(s) 114 such as a display, speakers, printer, etc. may also be included.

Computing device 100 also contains communication connection(s) 116 that allow the device to communicate with other computing devices 118, such as over a network or a wireless network. Communication connection(s) 116 is an example of communication media. Communication media typically embodies computer readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The term computer readable media as used herein includes both storage media and communication media.

Although the invention has been described in language that is specific to structural features and/or methodological steps, it is to be understood that the invention defined in the appended claims is not necessarily limited to the specific features or steps described. Rather, the specific features and steps are disclosed as forms of implementing the claimed invention. Since many embodiments of the invention can be made without departing from the spirit and scope of the invention, the invention resides in the claims hereinafter appended.

What is claimed is:

1. A computer-implemented method for providing interactivity for relational graphic solutions, the method comprising:
accessing a relational graphic solution, wherein the relational graphic solution includes a graphical representation of a relationship between a first function and a second function;
providing a first control point associated with the first function;
providing a second control point associated with the second function; and
associating the first control point and the second control point, wherein movement of one of the control points causes the movement of the other control point to a corresponding position.

2. The computer-implemented method of claim 1, wherein the first function is a circle function.

3. The computer-implemented method of claim 1, wherein the second function is at least one of: a sine function, a cosine function, and a tangent function.

4. The computer-implemented method of claim 1, further comprising a coordinate system associated with the relational graphic solution.

5. The computer-implemented method of claim 4, wherein the coordinate system is at least one of: a rectangular coordinate system, and a polar coordinate system.

6. The computer-implemented method of claim 4, wherein the coordinate system is a three-dimensional coordinate system and the relational graphic solution is a three-dimensional graphic solution.

7. The computer-implemented method of claim 1, further comprising a control point lead line extending from the first control point to the second control point.

8. The computer-implemented method of claim 1, wherein the first function is a circle function and the second function is at least one of: a sine function and a cosine function.

9. The computer-implemented method of claim 8, further comprising a positive lead line indicating a positive amplitude of the second function and a negative lead line indicating a negative amplitude of the second function.

10. A computer-readable medium having computer executable instructions for providing interactivity for relational graphic solutions, the instructions comprising:
providing a relational graphic solution, wherein the relation graphic solution includes a coordinate system, a first graphical representation of a first mathematical function, a second graphical representation of a second mathematical function, wherein the first mathematical function and the second mathematical function are mathematically associated;
determining a first control point associated with the first graphical representation of the first mathematical function;
determining a second control point associated with the second graphical representation of the second mathematical function; and
associating the first control point and the second control point, wherein the first control point is configured to automatically move to a corresponding point on the first graphical representation upon movement of the second control point and the second control point is configured to automatically move to a corresponding point on the second graphical representation upon movement of the first control point.

11. The computer-readable medium of claim 10, wherein the coordinate system is at least one of: a rectangular coordinate system, and a polar coordinate system.

12. The computer-readable medium of claim 10, wherein the coordinate system is a three-dimensional coordinate system and the relational graphic solution is a three-dimensional graphic solution.

13. The computer-readable medium of claim 10, wherein the first graphical representation includes a circle representation.

14. The computer-readable medium of claim 10, wherein the second graphical representation includes at least one of: a sine function representation, a cosine function representation, and a tangent function representation.

15. The computer-readable medium of claim 10, wherein associating the first control point and the second control point includes generating a control point lead line substantially between the first control point and the second control point.

16. A computer-implemented method for providing interactivity for a relational graphic solution, the method comprising:
providing a relational graphic solution, wherein the relational graphic solution includes a coordinate system, a circle graph and a trigonometric graph, wherein the trigonometric graph includes at least one of: a sine graph, a cosine graph and a tangent graph;
providing a circle control point associated with the circle graph;
providing a trigonometric control point associated with the trigonometric graph;
associating the circle control point with the trigonometric control point, wherein the association includes:
configuring the circle control point to automatically move to a corresponding point upon movement of the trigonometric control point; and
configuring the trigonometric control point to automatically move to a corresponding point upon movement of the circle control point.

17. The computer-implemented method of claim 16 wherein the circle includes a radius and providing a relational graphic solution includes selecting a radius.

18. The computer-implemented method of claim 16 wherein the coordinate system is at least one of: a rectangular coordinate system, and a polar coordinate system.

19. The computer-implemented method of claim 16 wherein the coordinate system is a three-dimensional coordinate system and the relational graphic solution is a three-dimensional graphic solution.

20. The computer-implemented method of claim 16 wherein associating the circle control point and the trigonometric control point further includes generating a control point lead line substantially between the circle control point and the trigonometric control point.
